(19) United States
(12) Patent Application Publication
(10) Pub. No.: US 2023/0175970 A1
(43) Pub. Date: Jun. 8, 2023

(54) FIBER OPTIC MEASUREMENT DEVICE

(71) Applicant: Indian Institute of Technology Madras (IIT Madras), Chennai (ID)

(72) Inventors: Raghavendra Sai, Chennai (TN); V V Lakshmana Swamy, Chennai (TN)

(73) Assignee: Indian Institute of Technology Madras (IIT Madras), Chennai (IN)

(21) Appl. No.: 17/765,442

(22) PCT Filed: Aug. 30, 2021
(86) PCT No.: PCT/IN2021/050837

§ 371 Date: Mar. 31, 2022

(30) Foreign Application Priority Data
Aug. 28, 2020 (IN) 202041037222

(51) Int. Cl. G01N 21/77; G01N 21/43

(52) U.S. Cl. CPC G01N 21/7703; G01N 21/431; G01N 2021/1789

(57) ABSTRACT

The disclosure proposes a portable fiber optic measurement device (100) for physical, chemical, and biological sensing applications that facilitates real-time monitoring. The device (100) includes a fiber optic probe cartridge (120) that is removably attached to a measuring device (110). The device (110) includes a light source, a detector, and the associated electronic measurement and control unit along with a display. The device (100) is configured to measure the real-time changes in the light intensity on the fiber probe cartridge side (130). With a U-bent fiber optic probe cartridge (138) as an example, the device (100) is configured to measure the bulk solution refractive index changes, effective refractive index change, or characteristic optical property of analytes including ions, chemical and bio molecules, polymers, compounds, microorganisms present on the fiber core surface (138). The key facets of this device include high sensitivity, real-time and rapid analysis, handheld, and portable instrumentation at meager operational cost.

### CROSS-REFERENCES TO RELATED APPLICATIONS

This application is a complete specification of provisional patent application no. 202041037222 entitled “FIBER OPTIC MEASUREMENT DEVICE” filed on Aug. 8, 2020.

### FIELD OF THE INVENTION

The invention relates generally to sensors for physical, chemical or biological entities and in particular to a portable measuring device that uses fiber optic or other waveguides to measure the characteristic optical property of a sample or the concentration of analytes of interest in a sample.

### DESCRIPTION OF THE RELATED ART

Precise measurement of physico-chemical properties, and concentration of chemicals and biomolecules is very important in various fields including medical science, environmental monitoring, and agricultural, chemical and food industries. Optical properties are widely exploited to these purposes. For example, refractive index measurements provide an excellent estimate of physico-chemical property of a system. Similarly, optical absorbance or colour change is highly utilized for the estimation of chemical and biological species. In particular, the current practices for biomolecular analysis rely on the conventional methods including enzyme-linked immunosorbent assay (ELISA) and chromatography. However, these methods are limited due to the highly sophisticated design and strenuous experimental procedures and the need for specific infrastructure. Also, these methods are time-consuming and of high cost. Fiber optic sensing systems over 30 years of innovation have evolved as an excellent alternative due to its unique features such as affordability, compactness, remote sensing capabilities, simple instrumentation, and high accuracy.

Fiber sensors of varying geometries have evolved; however, the ergonomic design of U-bent probes facilitate ease in coupling without the need of any fiber connectors, unlike other similar systems. More often, these fiber optic sensors are limited by the requirement to use sophisticated optical fiber connectors to obtain a precise optical coupling mechanism for a reliable output of the device. Some systems include the use of ceramic or metallic ferrules to surmount the fiber coupling issues. These ferrules are tube-like structures that are manufactured with the varying outer diameter and core diameter depending on fiber being used. Though these ferrules offer a simple plug type to optical coupling, the arrangement is limited by ferrule bore diameter mismatch, concentricity variations, non-circularity of the ferrule, lateral misalignment, end separation problems, and angular misalignment, among other possible issues.

A wide variety of fiber optic sensing systems can be realized for physical, chemical, and biological sensing applications. A high demand exists for a reliable, affordable system with simple instrumentation with a repeatable optical coupling mechanism that facilitates easily detachable sensor probes as well as real-time monitoring.

Indian patent application no. 201641026626 describes a fiber optic array sensor system with a U-bent fiber sensor probe array suitable for detection of chemical or biological species and multi-analyte analysis in clinical and pharmaceutical applications. US patent publication no. 20110207237A1 describes a biosensor having an optical fiber having at least one curved portion configured to enhance penetration of evanescent waves, one or more nanoparticles associated with the optical fiber, and configured to enhance localized surface plasmon resonance. European patent publication 2274594A2 describes systems and methods for performing optical spectroscopy using a self-calibrating fiber optic probe. U.S. Pat. No. 5,828,798A describes methods and apparatus for inexpensive and accurate sensing with the use of a fiber optic guide in the presence or absence of a particular substance (“analyte”). T. Kundu et al. (2010) describes the development of a label-free-optic biosensor based on evanescent wave absorbance to detect the presence of analytes such as bacteria, virus and some clinically important proteins. Rivero et al. (2017), describes a wide range of optical fiber devices for monitoring biological, chemical, medical or physical parameters.

Though, the current state of the art provides fiber optic array sensors, the systems are complex to operate and require elaborate procedures to obtain results. There is therefore need for a compact measuring device to monitor analytes using U-bent optical sensors.

### SUMMARY OF THE INVENTION

In various embodiments a portable fiber optic measurement device is disclosed. The device includes an LED light source integrated with a photodetector, wherein the LED source is configured to send light through an optical fiber probe, and the photodetector is configured to receive light after measurement. A power supply to the device is configured to supply a constant current to the LED. The device further includes a processor configured to control the power supply and to measure the amount of light power received at the photodetector, wherein the intensity of light measured by the photodetector is characteristic of interaction with the sample.

In various embodiments the device includes a housing provided with a light-proof interface for inserting a first optical fiber to receive light from the LED source to illuminate a sample and a second optical fiber to convey light from the sample after interaction therewith. In various embodiments a probe cartridge having a U-bent fiber probe, wherein the ends of the fibers at the probe cartridge are configured to fit into the light-proof interface, wherein the U-bent portion comprises a surface for sensing a physical property or functionalized for sensing a chemical or biological species.

In some embodiments the probe cartridge is configured to have two separate optical fibers, a first fiber configured to illuminate a sample and the second fiber configured to receive light from the sample, and wherein the ends of the first and second fibers at the probe cartridge are configured to fit into the light-proof interface.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1 shows the front perspective view of the handheld fiber optic measurement device with an inserted probe cartridge assembly into a custom made LED-PD housing according to an embodiment of the present invention.

FIG. 2A shows the portable fiber optic measurement device with fiber optic reflection probe cartridge for substrate analysis

FIG. 2B shows the portable fiber optic measurement device with fiber optic waveguide cartridge for droplet/cuvette analysis—Absorbance measurement.

FIG. 2C shows the portable fiber optic measurement device fiber optic waveguide cartridge for droplet/cuvette analysis—Fluorescence measurement.

FIG. 2D shows a portable fiber optic measurement device with U-bent fiber optic probe for analyte measurement.

FIG. 2E shows the enlarged view of the U-shaped sensor region of the disposable fiber optic probe.

FIG. 3 shows the detail of the optical source and detector and arrangement for coupling of the sensor to the device.

FIG. 4 shows the detailed block diagram of the optical system for a fiber optic measurement device.

FIG. 5 shows the response of the fiber optic sensor with a U-bent probe to the sucrose solutions of varying RI value.

FIG. 6 shows the response of the fiber optic sensor with a U-bent probe to the different %weight/volume concentrations of sucrose solutions at the room temperature and 60° C.

FIG. 7A shows the device response in real-time to the gold nanoparticle (AuNP) binding to the amine-functionalized U-bent probe when the U-bent probe cartridge is dipped in a AuNP solution.

FIG. 7B shows the device response to refractive index changes in terms of optical absorbance and its resolution.

FIG. 8A shows the temporal absorbance obtained from sensor probes using the fiber optic measurement device due to binding of AuNP label complexed with varying analyte concentrations.

FIG. 8B shows the dose response obtained from sensor probes using the fiber optic measurement device due to binding of AuNP label complexed with varying analyte concentrations.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The disclosure proposes a portable fiber optic measurement device that includes a probe cartridge that is removably attached to the measuring device. The probe cartridge is inserted into the analyte measuring device to align with a light source in the device and with a light detector to measure based on the interaction of light with the sample. In one embodiment the device is configured to analyze a substrate. In another embodiment the device may measure the absorbance in a solution. In some embodiments, the device may analyze the analyte in a sample. In one embodiment the probe cartridge is disposable, while in some, the cartridge may be reused with a disposable fiber optic sensor probe.

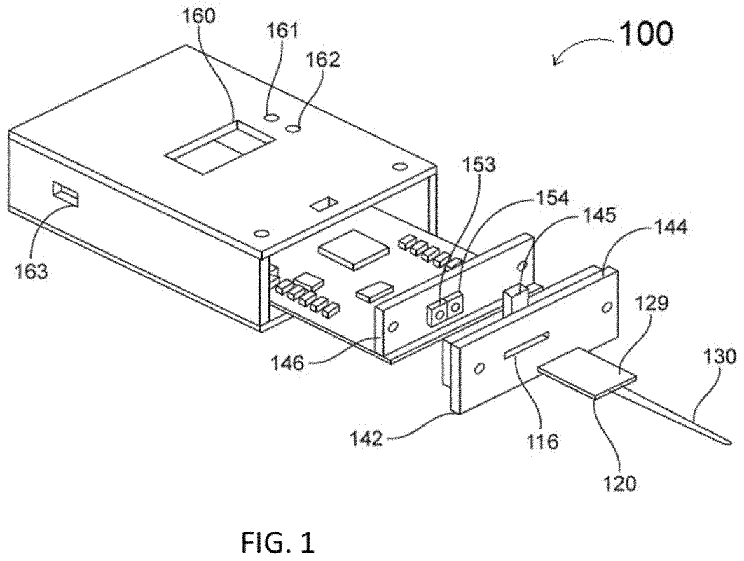

In various embodiments a portable fiber optic measurement device 100 is disclosed. In various embodiments the optical device as shown in FIG. 1A includes a LED light source 153 integrated with a photodetector 154. The LED source 153 is configured to send light through an optical fiber probe 130, and the photodetector 154 is configured to receive light for measurement after interaction with the sample. The device 100 includes a power supply configured to supply a constant current to the LED. The device in some embodiments is powered through a USB port.

In various embodiments the processor is configured to control the power supply for maintaining constant current to the LED. In various embodiments, the device may include electronic circuitry with signal conditioner and amplifier portions that are configured to send a readable measurement of the amount of light power received at the photodetector. In various embodiments the intensity of light measured by the photodetector is characteristic of interaction with the sample. In some embodiments, the light measured by the photodetector may indicate be characteristic of refractive index of the medium contacting the probe surface. In some embodiments, the functionalized surface may interact with chemical or biological species to cause absorption or loss of light characteristic of the species.

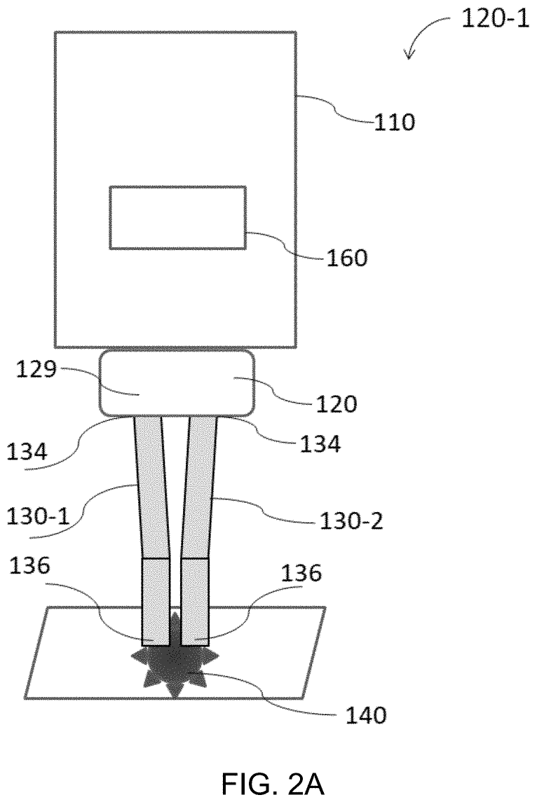

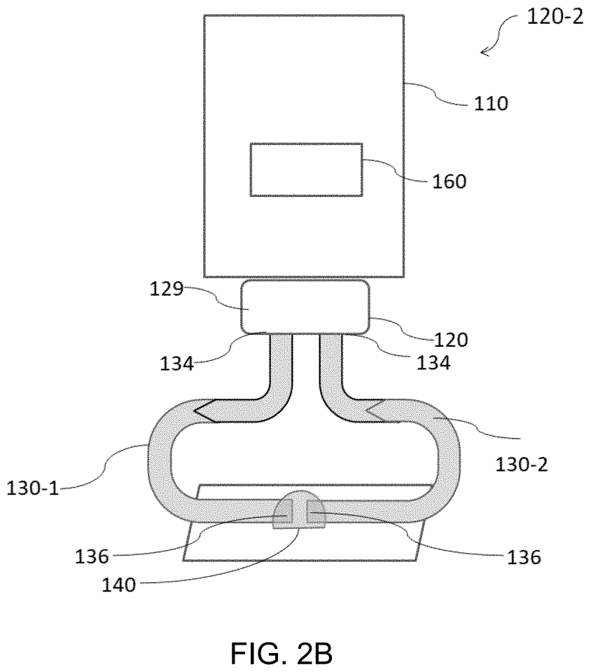

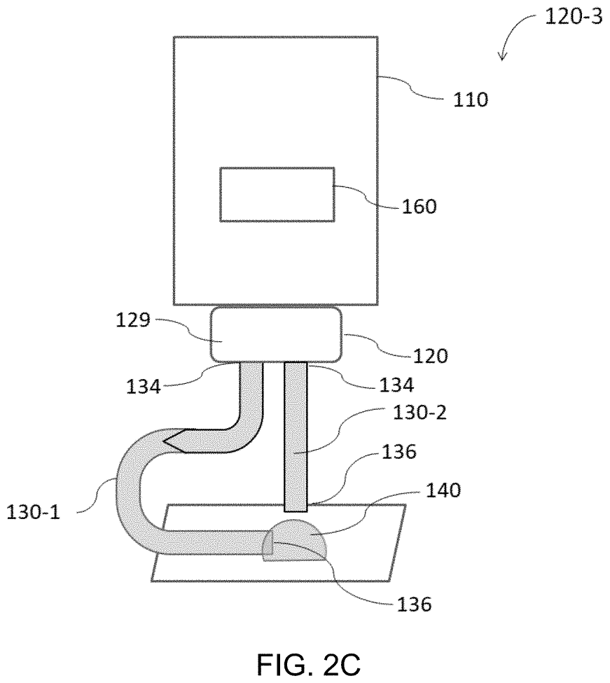

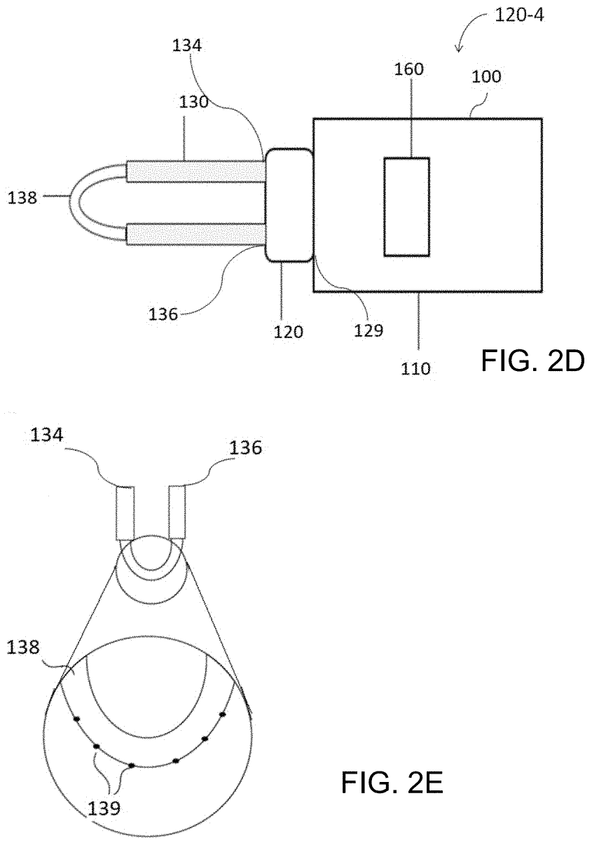

In various embodiments the device 100 may be configured to receive different types of probe cartridges 120-1 to 120-4 as shown in FIG. 2A-2D. In one embodiment, a probe cartridge 120-1 includes a housing 129 provided with a light-proof interface for inserting a first optical fiber 130-1 to receive light from the LED source to illuminate a sample 140 and a second optical fiber 130-2 to convey light from the sample 140 after interaction therewith. In one embodiment the sample 140 is placed over a slide as shown in FIG. 2A. The first probe 130-1 receives light from the LED source and illuminates the sample. The photo detector receives light from the sample through the second probe 130-2, wherein the probe acts as a reflection probe receiving reflected light from the substrate. In various embodiments the probe 120-1 may be used to provide analysis of a substrate.

In another embodiment the sample is held in a cuvette or as a droplet as shown in FIG. 2B, using a probe cartridge embodiment 120-2. The first probe 130-1 transmitting light from the light source and the second probe 130-2 sending light back to the photodetector act as waveguides. The device measures the absorbance of the sample. In another embodiment the device measures the fluorescence of the sample. An optic fiber probe setup 120-3 for measurement of fluorescence from a sample is as shown in FIG. 2C.

In some embodiments the device includes one optic probe 120-4 as shown in FIG. 2D, to measure an analyte in a sample. The device 100 includes a probe cartridge 120 and an analyte measuring device 110 as shown in FIG. 2D. The probe cartridge 120 as shown in FIG. 2D includes an external housing and an insertable cartridge end 129. In various embodiments the fiber optic probe 130 has a first distal end 134, a second distal end 136, and a U-shaped sensor region 138 coated with analyte-specific reactive elements. The probe 130 is held between a top housing portion, the bottom housing portion and the first distal end 134 and the second distal end 136 protrude from the probe cartridge 120 at the insertable cartridge end 129. In various embodiments the fiber optic probe is functionalized before being inserted into the cartridge. When fabricating the U-bent fiber, the two parameters namely (i) core diameter (ii) bend diameter are selected considering the required application.

In various embodiments the species to be detected in a sample may be a chemical or biological species and the absorption of evanescent waves at the probe 130 may be characteristic of concentration of the species. In some embodiments the probe is an optical fiber probe with a silica core or polymethyl methacrylate core. The U-bent region 138 of the fiber optic sensor probe 130 may be modified prior to exposure for sensing. In some embodiments the U-bent portion may be decladded or coated with specific reagents before exposure to the sensing environment. In some embodiments the U-bent portion is decladded and coated with chemically-active functional layer or metallic nanoparticles conjugated with an analyte-specific recognition element for label-free sensing of the analyte. An enlarged view of the U-shaped sensor region of the disposable fiber optic probe is shown in FIG. 2E.

In some embodiments, the nanoparticles may be conjugated with a recognition antibody, configured to cause binding of the species in the sample with the capture antibody to detect presence of the species. In some embodiments the analyte-specific recognition element is a chemical functional group, chemical receptor molecule, a polymer, a metal organic framework, an antibody, an aptamer, an enzyme, a protein, a nucleic acid, a cell, a microorganism, tissue or a fragment thereof. In some embodiments, sandwich assay based labeled plasmonic sensing is performed using the device 100. The sample to be detected is allowed to complex to the capture antibody on the probe surface and is sandwiched between the capture and the plasmonic-labelled recognition elements. The plasmonic complex present on the surface of the probe absorbs evanescent waves, giving a measurable change in light output characteristic of the measured biological species.

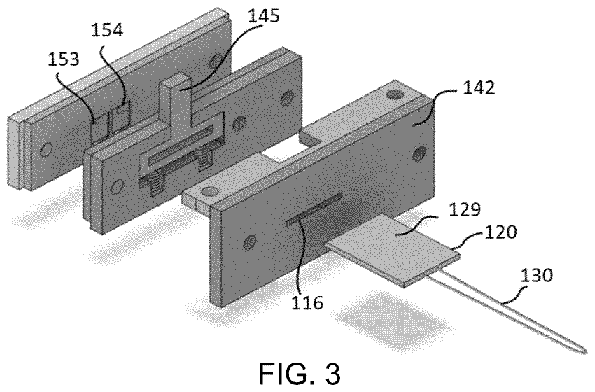

In various embodiments the measuring device 110 is an optical system as shown in FIG. 3. The device 110 includes a probe receiving arrangement having a first region 142, a second region 144 having a mechanical switch 145, and a third region 146 having a light source 153 and a light detector 154. Each of the regions may be rectangular layered sheets of a material, such as acrylic. The first region 142 is configured for insertion of the probe cartridge carrying a fiber optic probe therein. The probe cartridge reception slit 116 is dimensioned in accordance with the dimensions of the cartridge, such that the protruding distal ends of the probe are precisely inserted. In various embodiments, a small protrusion 145 in the second region 144 is designed to operate as a mechanical button switch, which enables the opening of the cartridge slit 116 only when the probe-cartridge assembly is introduced. It prevents the contamination of the slit area 116 from dust and other contaminant particles floating in the air and eliminates the interference of ambient light. In turn, this facilitates the efficient coupling of light during the sample analysis. In various embodiments the light source 153 is a pair of LED.

In various embodiments the first distal end 134 is aligned with the light source 153 to receive light and transmit to the U-shaped region for light to interact with the sample In various embodiments the second distal end 136 is aligned with the light detector 154 to deliver light from the U-shaped region to the light detector 154 after interaction with the sample. The light interacts with the medium at the U-bent region and the light array from the U-bent region is coupled to the light detector. A voltage is generated in response to the light received by the light detector that indicates the intensity of light received. In various embodiments the light intensity is a characteristic of is a function of the concentration of detected species.

In various embodiments, the optical system also includes, push-buttons 161 to perform the device self-calibration, and thereafter a test button 162 to start the analysis. The word “self-calibration” means, adjusting the PD 164 output voltage to operate it on the active region just below the saturation level. In some embodiments the programmable microcontroller 151 may be a Arduino Nano microcontroller programmed to perform the calibration when the sensor probe is connected to the device powered through a USB 163.

In various embodiments when light is coupled from the light source 153 into one end of the U-bent optic probe 130, the optical absorption is detected at the detector 154 end of the device 100. In some embodiments the optical absorption is a function of the refractive index or evanescent wave absorbance. In various embodiments the concentration of the detected analyte in each sample is determined from the optical absorption that is a function of the concentration of the chemical or biological species in the sample. In various embodiments the species to be detected in a sample using the device 100 is a chemical element such as heavy metal ions, a chemical molecule, a protein, a nucleic acid or a microorganism, or a fragment thereof.

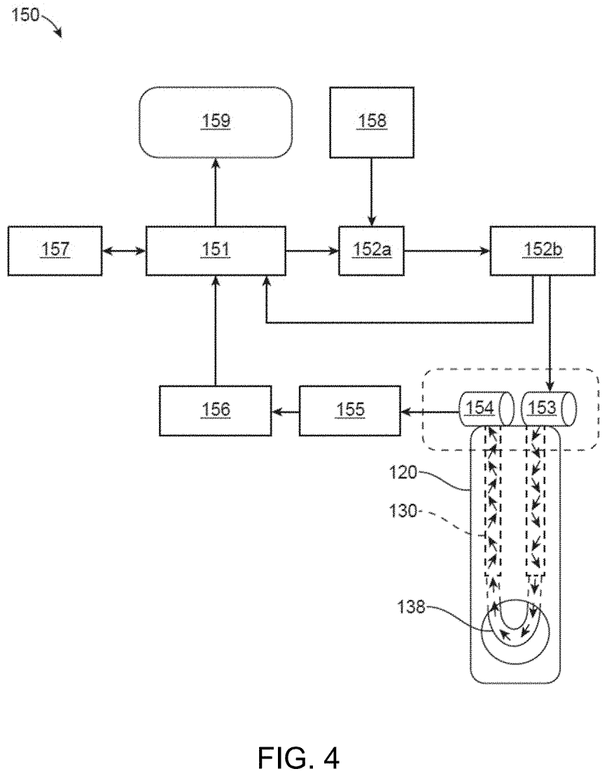

In various embodiments the device comprises a processor or microcontroller configured to process the signal in the light detector and measure the analyte in the sample. This is part of the optical system in the device. In various embodiments, in FIG. 4, the detailed block-level representation of the optical system of the device is described. It comprises a programmable microcontroller 151, a Digital to Analog Converter (DAC) 152a, a constant current LED driver circuit 152b using an op-amp, a single LED 153 and a photodetector (PD) 154, an Analog to Digital Converter (ADC) 156, a current to voltage (I-V) and a low pass filter circuit 155. The Optical system continuously interrogates the sample under analysis by coupling the light from the source down 153 the U-bent probe to the detector 154, where the detector 154 converts the incoming light energy to the electrical signal. The excitation light source 153 is a Light Emitting Diode (LED), that is configured to emit Infra-Red (IR), green or Ultra-Violet (UV) light and a detector is a photodiode/phototransistor. The main function of the microcontroller 151 is processing the signal, data handling, and storage. The device further comprises a USB to serial converter that allows the serial communication of the device with an operating system.

A constant current driver circuit 152b is designed to ensure that current driven to the light source 153 is maintained at the desired level. The circuit consists of an operational amplifier (op-amp) in a negative feedback configuration and it causes the op-amp to increase or decrease its output current until the voltage across the resistor matches the control voltage applied to the non-inverting input terminal. The control signal to the non-inverting terminal of the op-amp is provided by the digital to analog converter, which in turn requires a constant reference signal for its operation. This reference voltage is provided by a constant reference voltage IC 158 that maintains a constant output voltage, even ambient temperature or supply voltage varies. Thereby controlling the LED current, the light incident on the photodetector 154 was controlled. Thus it allows the detector to operate in its active region just below the saturation level.

Another electronic design aspect is a current to voltage (I-V) 155 converter connected to the photodetector 154, which is used to convert the detector output current to voltage and a low pass filter (LPF) circuit followed by PD to mitigate the level of electromagnetic interference noise in the PD detected signal. After filtration, the signal passes to an ADC 156. Thereafter the signal is fed to the microcontroller 151, which in turn is connected to a display unit 160 by which the PD voltage can be visualized for a user.

In various embodiments the fiber optic measurement device further includes a user input interface and a display. In various detailed embodiments, the fiber optic measurement device is configured to facilitate either of three modes of measurement display. (i) it may be equipped with a universal serial bus port configured to receive power from and facilitate communications between the processor and an external computing device, (ii) it may be equipped with a smart-phone interface, and (iii) it may also include a display coupled to the processor and configured to display a test result.

In some embodiments a method of performing a sample analysis using the fiber optic measurement device is disclosed. The method includes attaching the cartridge with the probe to the optical device so that the light from the optical device is received at one end of the fiber optic probe. The method further includes calibrating the device and dipping the U-bent region of the fiber into the test sample for analysis. The word “self-calibration” means, adjusting the PD output voltage to operate it on the active region just below the saturation level. The device is then powered up and the analysis is done. In one embodiment the fiber is disposable. In another embodiment the fiber is reusable.

The advantages of the handheld fiber optic measurement device include (i) elimination of the use of optical components such as lenses, beam splitters, or mechanical components such as fiber optic connectors or ferrules for an efficient optical coupling with bare fiber optic probes, (ii) efficient sealing off of the LED and the PD from the ambience in the absence the probe cartridge as well as stable engagement of the replaceable probe cartridge with the LED and PD using the spring-loaded flange. This enables prevention of contamination of the coupling area from dust and contaminant particles floating in the air and eliminates the interference of ambient light, thus facilitating a reliable sample analysis. This is because the U-bent fiber facilitates the placement of LED and PD on the same side. The light couplings between the distal ends of the fiber optic probe are maximized in an efficient manner, by placing the light source and light detector in a detector module that is a self-contained unit with its own customized housing. The invention also allows use of a disposable fiber optic probe into a probe cartridge, and facilitating an accurate alignment of the distal ends of the fiber optic probe with the light source and light detector upon insertion of the probe cartridge into the fiber optic measurement device. Since the performance and the reliability of the device significantly depend upon the coupling mechanism, this design eliminates the limitations caused by the use of ferrule such as difficulties in inserting the bare fiber ends into the ferrule, blockage of the ferrules by fiber breakage inside the ferrule and difficulties in maintenance. The device provides high sensitivity, real-time and rapid analysis, is handheld, and has portable instrumentation at meager operational cost.

### EXAMPLES

### Example 1: Optical Set-Up and Fabrication of the Device

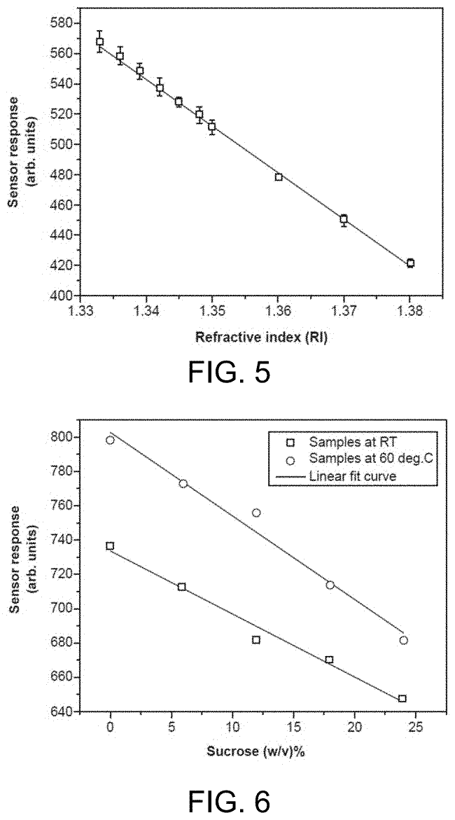

Straight silica fibers of core diameter 500 micron were bent into a U-shape with 1.5 mm bend diameter in accordance with the procedure. After the fabrication, the U-bent fiber was inserted into the custom made cartridge. Then both the ends of U-bent fiber were polished and the decladded portion was cleaned using ethyl acetate. Once the probe cartridge assembly was ready, it was inserted into the probe cartridge receiving block. The optical set-up for the RI sensing application includes a bare U-bent fiber probe, which was connected to a pair of Green LED (530 nm) and a Photodarlington photodetector housed in the custom made probe-cartridge receiving block of the device. Using the calibration push-button, initially, the device performs the self-calibration when it was powered through the USB. Once the calibration was done, the test button was pressed to initialize the microcontroller to start the analysis. Then the sensor region of the U-bent fiber was subjected to the sucrose solutions in the increasing order of their RI. The sensor response using the device was measured and PD detector output was visualized in real-time through the inbuilt display connected to the optoelectronic circuit of the device in terms of voltage. FIG. 5 and FIG. 6 illustrate application of the fiber optic sensor for refractive index sensing. FIG. 5 shows dose response curve obtained from a U-bent polymeric optical fiber (POF) sensor. It shows the PD output voltage of the FOS as a function of RI of the sucrose sample solutions varying from 1.333 to 1.38. Sucrose solutions of different concentrations with a refractive index between 1.333 and 1.348 with an increment of 0.003 and from 1.35 to 1.38 with an increment of 0.01 were prepared by adding varying W/W % of sucrose in DI water.

### Example 2: Device Applications

A U-bent POF probe having a length of 4.8 cm was used for the RI sensing study. All the measurements are done in triplicate and carried out at room temperature (25° C.). In correspondence to the various responses obtained from the successive trials, the error bars were plotted using the evaluated standard deviation in the responses. The slope of the linearly fitted curve, corresponding to sensitivity (defined as the ratio of the change in intensity counts or voltage to the change in RI) is 3 V/RIU. Thus the sensitivity was found to be linear between 1.333 and 1.38 RIU as shown in FIG. 5.

FIG. 6 illustrates the detector output response of U-bent POF probe in the sucrose solutions of varying RI value at the room temperature and 60° C. temperature. To demonstrate the RI sensing performance of the device at the elevated temperature, the different concentrations of the sucrose, ranging from 0-30% (weight percent) corresponding to the RI values 1.333, 1.342, 1.35, 1.36 and 1.37 were taken. At room temperature, a bare U-bent POF probe of length 6.5 cm and 500 micron core diameter was dipped into the sucrose solutions in the increasing order of the RI value and the respective PD voltage values were recorded. Thereafter the vials containing the sucrose solutions were heated to 60° C. and fiber probe was introduced into the hot sucrose solutions in the increasing order of their RI values. The sensor response at room temperature as well as an elevated temperature of 60° C. were recorded and plotted in a single graph, FIG. 6. The sensitivity found to be 3 V/RIU and 4 V/RIU for probe at room temperature and at 60° C. respectively. Thus, the device is able to provide a distinguishable response when probe was subjected to different ambient conditions.

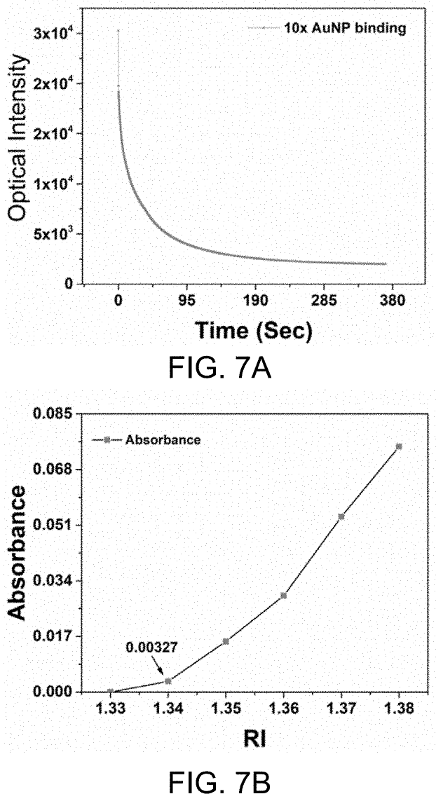

In addition to RI sensing application using a U-bent fiber optic probe, the fiber optic sensor device is capable of detecting the presence of the plasmonic nanoparticles on a fiber surface using the evanescent wave based absorbance (EWA). FIG. 7A and FIG. 7B illustrate the device response due to the binding of AuNP to an amine functionalized U-bent fiber optic probe upon exposure to AuNP solution (100 μL, 10×of OD=1). The data obtained from the device in terms of the intensity values as an output can be plotted as absorbance to appreciate the ability of the device to pick up small changes in the intensity. The device has an absorbance range of 0.00 to 1.05. The resolution of the absorbance measurements was down to 0.001 units.

BioSensor application of the fiber optic measurement device:

U-bent silica optical fiber (GOF) probe fabrication: The GOF consists of fused silica core surrounded by a silica clad, and a polymer buffer layer. U-bent GOF probes with optimal bend diameter were made using a customized CO₂ laser bending machine. Briefly, a 20 cm long piece of GOF with a 200 μm core diameter was subjected to the bending process with the help of a fiber bending machine (developed in-house), which is equipped with a CO₂ laser and motors capable of performing buffer ablation followed by bending of a straight portion of the fiber with the desired bend diameter. Thereafter, the bent fiber probes were sonicated and wiped with acetone to remove the black char and debris due to the ablation process. The U-bent region of the fiber probes was dipped into 40% HF solution for 5 minutes to remove the fused silica clad. (Note: The 5 minutes of etching time was optimized by microscopic examination of the diameter of fiber probes every few min of etching. The fiber diameter was measured after every minute until it reduced to 200 μm or lower to ensure complete etching of fluorinated silica clad layer.) Then, the decladded probes were washed with DI water and sonicated in acetone for 2 to 5 mins.

Sensor probe functionalization and antibody immobilization: The U-bent silica fiber probes were cleaned by sonication in acetone (15 min, 1000 Watt, 28 kHz). The cleaned U-bent sensing region of the fiber probes was further cleaned with piranha solution (20 min, 60° C.) to oxidize and remove any organic contamination as well as generate hydroxyl groups on the sensor surface. Thereafter, the fiber probes were washed with DI water and heated at 115° C. for 1 hr for dehydration of the sensor surface. For amino-silanization, the fiber probes were dipped in a 1% solution of APTMS in a 5:2 (v/v) mixture of ethanol and acetic acid (5 min). This was followed by three-times washing of the fiber probes with ethanol and sonication (15 min) and hot air drying (100° C., 1 h). Then, the silanized sensor probes were incubated into 1% glutaraldehyde solution for 30 mins to generate the aldehyde functional groups, for covalent immobilization of the capture antibodies.

The functionalized sensor probes were immobilized with goat anti-human immunoglobulin G (GaHIgG, Fab specific), referred to as the capture antibody. The functionalized U-bent fiber optic sensor probes were incubated in 50 μL of 50 μg/mL of capture antibody solution overnight at 4° C. Then, the antibody immobilized sensor probes were washed thrice in PBS and dipped in 50 μL of 5 mg/mL of BSA solution for 20 mins in order to block the free functional groups (—OH and —CHO) on the sensor probe surface.

Gold nanoparticle (AuNP) synthesis and conjugation with detector antibodies: The gold nanoparticles were synthesized by citrate-mediated reduction of gold chloride. Briefly, 1 mL of 12.7 mM HAuCl₄ was added to 38 mL of DI water and heated to boil and followed by the addition of an aqueous solution of trisodium citrate dihydrate (0.349 mM, 1 mL) (citrate to gold molar ratio=1.1). The heating was continued until the solution color turns pale pink, indicating the formation of AuNPs. Thereafter, the solution was allowed to cool to RT and then stored at 4° C.

The plasmonic AuNP labels were prepared by utilizing the affinity of amine and thiol groups on the detector antibodies towards the gold nanoparticles. Briefly, 100 μL of 25 μg/mL goat anti-human immunoglobulin G (GaHIgG, Fc specific) was added to the 1 mL of colloidal solution of AuNP (˜1 OD, pH 8.5) and incubated for 15 mins at RT. Thereafter, 80 μL of 320 μM of SH-PEG was added and incubated for 15 mins. Then, the reaction mixture was centrifuged at 8000 RPM for 20 mins at 4° C. to remove any unbound and loosely bound antibodies. The clear supernatant was discarded and the AuNP labels were resuspended in 100 μL of phosphate buffer (PBS. pH 7.4) to obtain 10× concentration of AuNP conjugates.

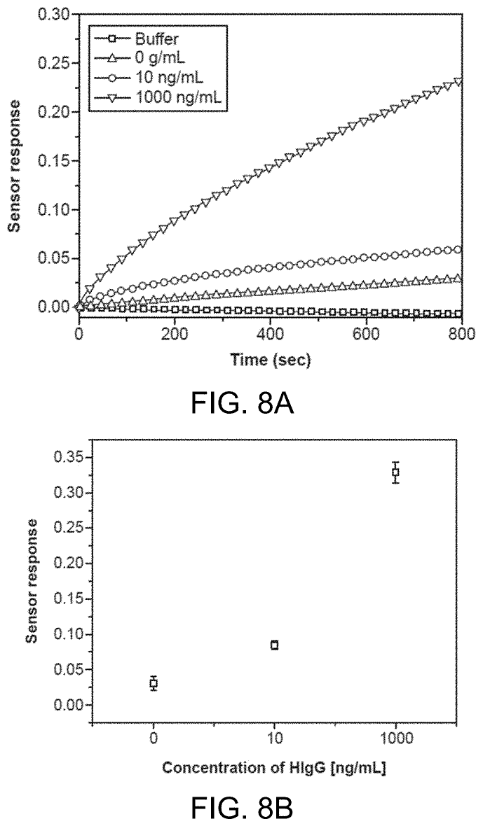

To demonstrate the biosensor application of the device, freshly-prepared antibody-immobilized U-bent probes were used to measure the device response to different HIgG analyte concentrations from 0 to 1000 ng/mL. Analyte solution (25 μL) was added to the AuNP conjugates (25 μL), mixed and incubated for 5 minutes before introducing the probe into the mixture. Prior to this, the antibody-immobilized U-bent fiber optic sensor probe was coupled to the device and the device was calibrated while the probe was dipped in PBS buffer. Up on the exposure of the probe to the mixture of the analyte and AuNP conjugates, the sensor response was recorded real-time. The device response was obtained for different concentrations of analyte. FIG. 8A and FIG. 8B shows the temporal absorbance response and the dose response measured by the device.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

We claim:

1. A portable fiber optic measurement device (100) comprising:
an LED light source (153) integrated with a photodetector (154), wherein the LED source (153) is configured to send light through an optical fiber probe (130), and the photodetector (154) is configured to receive light from the probe after measurement;
a power supply configured to supply a constant current to the LED; and
a processor (151) configured to control the power supply and to measure the amount of light power received at the photodetector (164), wherein the intensity of light measured by the photodetector (164) is characteristic of interaction with the sample.

2. The device 100 as claimed in claim 1, comprising a housing (129) provided with a light-proof interface for inserting a first optical fiber (130-1) to receive light from the LED source (153) to illuminate a sample (140) and a second optical fiber (130-2) to convey light from the sample (140) after interaction therewith.

3. The device 100 as claimed in claim 2, comprising a probe cartridge (120) having a U-bent fiber probe (130), wherein the ends of the fibers (134, 136) at the probe cartridge are configured to fit into the light-proof interface, wherein the U-bent portion (138) comprises a surface for sensing a physical property or functionalized for sensing a chemical or biological species.

4. The device 100 as claimed in claim 2, wherein the probe cartridge (120) is configured to have two separate optical fibers (130-1, 130-2), a first fiber (130-1) configured to illuminate a sample (140) and the second fiber (130-2) configured to receive light from the sample (140), and wherein the ends of the first and second fibers at the probe cartridge are configured to fit into the light-proof interface.
